(19) United States
(12) Patent Application Publication
(10) Pub. No.: US 2003/0200748 A1
(43) Pub. Date: Oct. 30, 2003

(54) Thermally-activated actuator

(75) Inventors: Susan C. Bromley, Bloomington, MN (US); Bradley J. Nelson, North Oaks, MN (US); Karl Vollmers, Crystal, MN (US); Arunkumar Subramanian, Minneapolis, MN (US); Eniko Enikov, Tucson, AZ (US); Kamal Deep Mothilal, Minneapolis, MN (US)

Correspondence Address: MERCHANT & GOULD PC, 3200 IDS CENTER, 80 SOUTH EIGHTH STREET, MINNEAPOLIS, MN, 55402-0903, US

(73) Assignee: ADC Telecommunications, Inc.

(21) Appl. No.: 10/136,703

(22) Filed: Apr. 30, 2002

(51) Int. Cl. H02N 10/00

(52) U.S. Cl. 60/527; 310/307

(57) ABSTRACT

An actuator having a hot-arm and a cold-arm wherein the hot-arm and cold-arm are vertically offset from one another. The hot-arm is heated to cause the actuator to move both vertically and horizontally. When used as a relay, an electrostatic force latches the actuator when the electrodes are brought in close proximity to one another.

### BACKGROUND OF THE INVENTION

Microelectromechanical systems (MEMS) have recently been developed as alternatives for conventional electromechanical devices such as relays, actuators, valves and sensors. MEMS devices are potentially low cost devices due to the use of microelectronic fabrication techniques. New functionality may also be provided because MEMS devices can be much smaller than conventional electromechanical devices.

Many applications of MEMS technology use MEMS actuators. For example, many sensors, valves and positioners use actuators for movement.

MEMS devices have relied upon various techniques to provide the force necessary to cause the desired motion within the microstructures. For example, cantilevers have been employed to transmit mechanical force in order to rotate micromachined springs and gears. In addition, some micromotors are driven by electromagnetic fields, while other micromachined structures are activated by piezoelectric or electrostatic forces. Recently, MEMS devices that are actuated by the controlled thermal expansion of an actuator or other MEMS components have been developed.

Thermally actuated MEMS devices that rely on thermal expansion of the actuator have recently been developed to provide for actuation in-plane, i.e., displacement along a plane generally parallel to the surface of the microelectronic substrate. In order to provide high isolation, the contacts need to be separated by a large distance thereby making it difficult to properly scale the device.

It is desirable to provide an actuator that has large displacement for high device isolation while maintaining a small structure. In addition, it is desirable to provide an actuator that has large contact closure force for low contact resistance.

Notwithstanding the MEMS actuators that have previously been proposed, a number of existing and contemplated MEMS systems, such as relays, actuators, valves and sensors require more sophisticated actuators that provide useful forces and displacements while consuming reasonable amounts of power in an efficient manner. Since it is desirable that the resulting MEMS systems be fabricated with batch processing, it is also preferred that the microelectronic fabrication techniques for manufacturing the resulting MEMS systems be affordable, repeatable and reliable.

### SUMMARY OF THE INVENTION

According to a first aspect of the invention, there is provided a microelectromechanical structure having a substrate, two spaced apart supports, a first and second beam. The substrate defines a reference plane. The two spaced apart supports are located on the substrate. The first beam has a proximal and distal end, the proximal end of the first beam is coupled to a first of the spaced apart supports wherein the first beam extends in a first plane parallel with the reference plane. The second beam has a proximate and a distal end, the proximal end of the second beam is coupled to the other of the spaced apart supports wherein the second beam extends in a second plane parallel with the reference plane wherein the second plane is vertically offset from the first plane. The distal end of the first beam to the distal end of the second beam, wherein the first and second beams are heated to cause the first beam to expand by a greater percentage than the second beam to move the distal end of the structure in a direction towards the reference plane.

According to a second aspect of the invention, there is provided a microelectromechanical structure having a substrate, a first and second beam and a connector. The substrate defines a reference plane. The first beam has a proximal and distal end, the proximal end of the first beam is supported above the substrate wherein the first beam extends in a first plane parallel with the reference plane. The second beam has a proximate and a distal end, the proximal end of the second beam is supported above the substrate wherein the second beam extends in a second plane parallel with the reference plane wherein the second plane is vertically offset from the first plane. The connector couples the distal end of the first beam to the distal end of the second beam, wherein the first beam is heated to cause the first beam to expand and move the distal end of the structure in a direction towards the reference plane.

According to a third aspect of the invention, there is provided a microelectromechanical structure having a substrate, a contact, and an actuator. The substrate defines a reference plane. The contact is located on the substrate. The actuator has a portion thereof suspended above the reference plane of the substrate, and includes a hot arm having a distal end and a cold arm having a distal end that is coupled to the distal end of the hot arm offset from the hot arm in a direction perpendicular to the reference plane. The hot arm receives an electric current to cause the hot arm to expand and move the distal ends of the hot and cold arms towards the contact located on the substrate.

For a further understanding of the nature and advantages of the present invention, as well as the preferred mode of use, reference should be made to the following detailed description read in conjunction with the accompanying drawings. In the following drawings, like reference numerals designate like or similar parts throughout the drawings.

### BRIEF DESCRIPTION OF THE DRAWINGS

FIG. 1 is a top view of a thermal actuator according to a preferred embodiment of the present invention.

FIG. 2 is a cross-sectional view of the actuator shown in FIG. 1 taken along line 2-2 in its unactuated position.

FIG. 3 is a cross-sectional view of the actuator shown in FIG. 1 taken along line 2-2 in its actuated position.

FIG. 4 is a cross-sectional view of an actuator according to another preferred embodiment of the present invention in its unactuated position.

FIG. 5 is a cross-sectional view of the actuator shown in FIG. 4 in a first actuated position.

FIG. 6 is a cross-sectional view of the actuator shown in FIG. 4 in a second actuated position.

### DETAILED DESCRIPTION OF THE PRESENTLY PREFERRED EMBODIMENTS

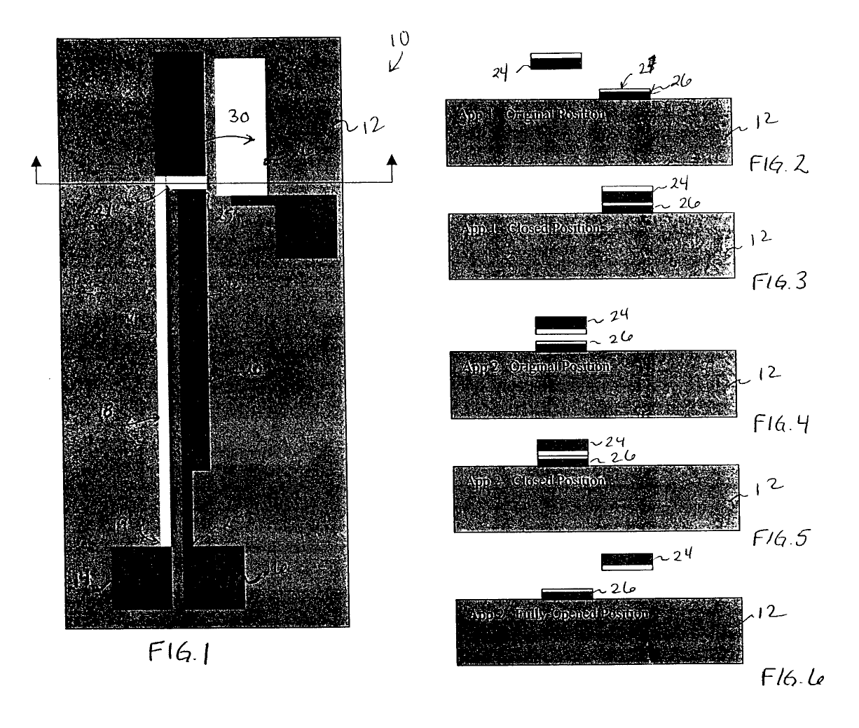

FIG. 1 is a top view of a thermal actuator 10 according to a preferred embodiment of the present invention. The thermal actuator 10 is formed on a substrate 12 and includes a first pad 14 and a second pad 16 spaced apart from the first pad 14. Located underneath the pads are a first and second support (not shown) that are formed on the substrate. The pads 14,16 provide current to the actuator 10 as will be described in detail hereinafter. A first beam 18 has a proximal end 19 and a distal end 21, the proximal end 19 is coupled to the first support 14 and the first beam extends in a first plane parallel to the plane of the substrate 12.

A second beam 20 has a proximal end 23 and a distal end 25, the proximal end 23 is coupled to the second support 16 and the second beam extends in a second plane parallel to the plane of the substrate 12. The second plane is different from the first plane so that the first and second beams 18, 20 are vertically offset from one another with respect to the substrate with beam 20 closer to the substrate 12 then beam 18.

FIG. 2 is a cross-sectional view of the thermal actuator 10 shown in FIG. 1 taken along lines 2-2 in its unactuated position. At the distal region of the actuator, the first beam 18 forms an “L” shape and is coupled to the distal end 25 of the second beam 20. Formed on the substrate is a lower electrode 26 covered by a layer of nitride 27. As can be seen in the cross-sectional view, the first and second beams 18,20 extend above the nitride layer 27 by a distance preferably ranging from about 1 to about 3 microns.

In a preferred embodiment, the first beam 18 is formed of a conductive material such as polysilicon, and the second beam 20 is formed of a conductive material such as metal. Alternatively, the first and second beams 18, 20 may be formed of the same conductive material such as polysilicon or a metal.

In a preferred embodiment the first beam 18 has a width W₁, and the second beam 20 has a width W₂. Preferably, width W₁ ranges from about a quarter to about half the size of width W₂. In a more preferred embodiment, W₁ is about a quarter of W₂. Of course, the beams 18, 20 may have other dimensions.

An upper electrode 24 is placed at the distal end 25 of the second beam 20 facing the substrate 12. A lower electrode 26 is placed on the substrate 12. The lower electrode 26 has a layer of nitride 25 deposited thereon. The electrode 24, 26 are preferably made of a conductive material such as metal, for example, copper or gold. If the actuator is to be used as a relay, contacts may be added.

The operation of the thermal actuator will now be described. A current source (not shown) is operatively coupled to the first pad 14 to supply current to the first beam 18. Current is conducted from pad 14, through beam 18 into beam 20 and back to pad 16. In response to receiving current, the first beam 18 thermally expands more than the second beam 20 because of its smaller width, thereby causing the distal end of the actuator to bend as shown by arrow 30. Because the first and second beams 18, 20 are vertically offset from one another, the distal end of the actuator 10 bends both in the plane of the substrate 12 and out of the plane of the substrate 12. Thus, there is both vertical and horizontal movement of the distal end of the actuator.

In providing vertical movement of the distal end of the actuator, as well as horizontal movement, the electrodes 24 and 26 can be brought into close proximity, about 2 microns of one another. If the actuator 10 is being used as a relay, as long as there exists a difference in potential between electrodes 24, 26, the two electrodes 24, 26 are attracted to one another by an electrostatic force to latch or close the relay. In a preferred embodiment, the electrode located at the distal end of the actuator is charged by the current flowing though the beams 18, 20 and the electrode located on the substrate is at ground. To unlatch the relay, current is removed from pad 14 so that the charge is removed from the electrode 24 and the natural spring in the beams 18, 20 returns the actuator to its unlatched position shown in FIG. 1. FIG. 3 is a cross-sectional view of the actuator in its closed position.

FIGS. 4-6 are cross-sectional views of an actuator according to another preferred embodiment in its unactuated, actuated and second actuated positions respectively. In this preferred embodiment, beams 18 and 20 are reversed so that the narrower beam 18 is closest to the substrate 12 and the wider beam 20 is further away from the substrate 12. In addition, lower electrode 26 is positioned directly underneath electrode 24. If an electrostatic force is developed between electrodes, the actuator can act as a relay and latch the electrodes as shown in FIG. 5. In this preferred embodiment, application of current to the actuator moves the actuator and lower electrode 26 further away from the substrate as shown in FIG. 6. The electrodes in this embodiment are fabricated in alignment as shown in FIG. 4 and in close proximity.

The preferred embodiments of the actuator provide improved contact isolation within a small footprint because the contacts are separated from each other in two directions.

In another preferred embodiment, the hot arm 18 of the thermal actuator may have a three-layer structure as described in U.S. patent application Ser. No. ______ entitled “Thermal Micro-Actuator Based on Selective Electrical Excitation” (Attorney Docket No. 2316.1428US01) filed concurrently herewith. With the potential differences correctly chosen, current will only flow through the hot arm and not the cold arm.

The present invention should not be considered limited to the particular examples described above, but rather should be understood to cover all aspects of the invention as fairly set out in the claims. Various modifications, equivalent processes, as well as numerous structures to which the present invention may be applicable will be readily apparent to those of skill in the art to which the present invention is directed upon review of the subject specification.

What is claimed is:

1. A microelectromechanical structure comprising:
a substrate defining a reference plane;
two spaced apart supports located on the substrate;
a first beam having a proximal and distal end, the proximal end of the first beam coupled to a first of the spaced apart supports wherein the first beam extends in a first plane parallel with the reference plane;
a second beam having a proximate and a distal end, the proximal end of the second beam coupled to the other of the spaced apart supports wherein the second beam extends in a second plane parallel with the reference plane wherein the second plane is vertically offset from the first plane and the distal end of the second beam is coupled to the distal end of the first beam; and
wherein the first and second beams are heated to cause the first beam to expand by a greater percentage than the second beam to move the distal end of the structure in a direction towards the reference plane.

2. The structure of claim 1 wherein the first and second beams are heated by applying a current to the first and second beams.

3. The structure of claim 1 wherein the first beam has a first width and the second beam has a second width wherein the first width is less than the second width.

4. The structure of claim 3 wherein the first width is half of the second width.

5. The structure of claim 3 wherein the first width is about a quarter of the second width.

6. The structure of claim 1 wherein the first beam is formed of a single material.

7. The structure of claim 6 wherein the second beam is formed of a single material different from the first beam.

8. The structure of claim 6 wherein the second beam is formed of a single material that is the same as the first beam.

9. The structure of claim 6 wherein the single material is polysilicon.

10. The structure of claim 1 further comprising:
a first electrode located on the distal end of the second beam facing the substrate; and
a second electrode located on the substrate wherein when current is applied to the first beam, the structure bends so that the first contact comes into contact with the second contact.

11. The structure of claim 3 wherein the first beam is further away from the substrate than the second beam.

12. The structure of claim 3 wherein the first beam is closer to the substrate than the second beam.

13. The structure of claim 1 wherein the first beam has a three-layer construction of conductive material sandwiching a layer of insulative material.

14. A microelectromechanical structure comprising:
a substrate defining a reference plane;
a first beam having a proximal and distal end, the proximal end of the first beam supported above the substrate wherein the first beam extends in a first plane parallel with the reference plane;
a second beam having a proximate and a distal end, the proximal end of the second beam supported above the substrate wherein the second beam extends in a second plane parallel with the reference plane wherein the second plane is vertically offset from the first plane; and
a connector coupling the distal end of the first beam to the distal end of the second beam;
wherein the first beam is heated to cause the first beam to expand and move the distal end of the structure in a direction towards the reference plane.

15. The structure of claim 14 wherein the first beam is heated by applying a current to the first beam.

16. The structure of claim 14 wherein the first beam has a first width and the second beam has a second width wherein the first width is less than the second width.

17. The structure of claim 16 wherein the first width is half of the second width.

18. A microelectromechanical structure comprising:
a substrate defining a reference plane;
a contact located on the substrate;
an actuator having a portion thereof suspended above the reference plane of the substrate, the actuator comprising:
a hot arm having a distal end;
a cold arm having a distal end that is coupled to the distal end of the hot arm offset from the hot arm in a direction perpendicular to the reference plane;
wherein the hot arm receives an electric current to cause the hot arm to expand and move the distal ends of the hot and cold arms towards the contact located on the substrate.

19. The structure of claim 18 wherein the cold arm is located closer to the substrate than the hot arm and the structure further comprising a second electrode located on the distal end of the cold arm.

20. The structure of claim 18 wherein the hot arm has a first width and the cold arm has a second width wherein the first width is less than the second width.

21. The structure of claim 20 wherein the first width is half of the second width.

22. The structure of claim 20 wherein the first width is about a quarter of the second width.

23. The structure of claim 18 wherein the hot arm is formed of a single material.

24. The structure of claim 23 wherein the cold arm is formed of a single material different from the hot arm.

25. The structure of claim 23 wherein the cold arm is formed of a single material that is the same as the hot arm.

26. The structure of claim 23 wherein the single material is polysilicon.

27. The structure of claim 21 wherein the hot arm is located further away from the substrate than the cold arm.

28. The structure of claim 21 wherein the cold arm is located closer to the substrate than the hot arm.
